(19) United States
(12) Patent Application Publication
(10) Pub. No.: US 2025/0286303 A1
(43) Pub. Date: Sep. 11, 2025

(54) CONDUCTOR TERMINAL AND METHOD FOR ASSEMBLING A CONDUCTOR TERMINAL

(71) Applicant: WAGO Verwaltungsgesellschaft mbH, Minden (DE)

(72) Inventors: Rudolf MASTEL, Minden (DE); Tjorben KUHN, Diepenau-Nordel (DE)

(73) Assignee: WAGO Verwaltungsgesellschaft mbH, Minden (DE)

(21) Appl. No.: 19/075,759

(22) Filed: Mar. 10, 2025

(30) Foreign Application Priority Data
Mar. 11, 2024 (DE) 10 2024 106 917.1

(51) Int. Cl. H01R 13/424; H01R 13/502; H01R 43/20

(52) U.S. Cl. CPC H01R 13/424; H01R 13/502; H01R 43/20

(57) ABSTRACT

A conductor terminal, which includes an insulating housing and a contact insert for connecting an electrical conductor. The insulating housing includes a first housing part, which has a plug contour, and a second housing part. The first housing part has a receiving chamber with two side walls situated opposite each other for receiving the contact insert. A distance between the side walls situated opposite each other defining a chamber width of the receiving chamber. The mating plug contour of the second housing part is designed to reduce the chamber width of the receiving chamber, at least in sections, during the establishment of a plug connection between the plug contour of the first housing part and the mating plug contour of the second housing part by at least partially deforming and/or displacing at least one side wall of the receiving chamber of the first housing part.

This nonprovisional application claims priority under 35 U.S.C. § 119(a) to German Patent Application No. 10 2024 106 917.1, which was filed in Germany on Mar. 11, 2024, and which is herein incorporated by reference.

### BACKGROUND OF INVENTION

### Field of the Invention

The invention relates to a conductor terminal, which includes an insulating housing and a contact insert, for connecting an electrical conductor. The invention furthermore relates to a method for assembling a conductor terminal.

### Description of the Background Art

In general, the invention relates to the field of electrical connecting technology. Conductor terminals are used, in particular, to clamp an electrical conductor and to establish an electrically conductive connection between the electrical conductor and a connecting contact of the conductor terminal with the aid of a contact insert.

For reasons of economic feasibility, a cost-effective manufacturing of conductor terminals is preferred. For example, efficient manufacturing processes suitable for mass production are therefore striven for. At the same time, a high reliability, long service life, and easy handling of the provided conductor terminals are required, so that the component quality may not be impaired by economical manufacturing processes. For example, it is desirable for the contact insert of the conductor terminal to be aligned precisely in the insulating housing, so that a connecting operation may be carried out easily and reliably. A precise arrangement of the contact insert in the insulating housing is, however, associated with increased complexity in terms of production engineering, since narrow tolerances may make it more difficult to mount the contact insert in the insulating housing. The ability to reconcile these contradictory requirements presents a technical challenge when developing conductor terminals.

DE 10 2004 014 353 B4 discloses a plug or a socket of a plug connection, which includes a contact partner having a contact element in the form of a spring clip. This contact element protrudes over the outer parts of the contact partner and, in the plugged-in state in a receiving carrier, applies a contact and holding force to an electrical line.

### SUMMARY OF THE INVENTION

It is therefore an object of the invention to provide an improved conductor terminal, which includes an insulating housing and a contact insert and which may be manufactured with economic efficiency and permits a connecting operation which may be carried out easily and reliably.

A conductor terminal is proposed, which includes an insulating housing and a contact insert, for connecting an electrical conductor, the insulating housing including a first housing part having a plug contour and a second housing part having a mating plug contour, which is configured for plug-in connection to the plug contour of the first housing part. The first housing part has a receiving chamber with two side walls situated opposite each other for receiving the contact insert. A distance between the side walls situated opposite each other defines a chamber width of the receiving chamber, the mating plug contour of the second housing part being designed to reduce the chamber width of the receiving chamber, at least in sections, during the establishment of a plug connection between the plug contour of the first housing part and the mating plug contour of the second housing part by at least partially deforming and/or displacing at least one side wall of the receiving chamber of the first housing part.

In other words, a conductor terminal including a connectable insulating housing is proposed, whose receiving chamber may be narrowed during the connection of the insulating housing by means of component structures of the insulating housing in such a way that the contact insert arranged in the receiving chamber is oriented and fixed in the narrowed receiving chamber. This makes it possible to easily arrange the contact insert in one part of the insulating housing, in particular with clearance, during manufacturing and to achieve a fixing of the contact insert in the receiving chamber only in a final assembly step when fastening the further part of the insulating housing, a clearance of the contact insert which may be present in the receiving chamber being advantageously reduced or eliminated entirely. In addition, a self-centering of the contact insert in the receiving chamber may be facilitated by the chamber narrowing, so that a precise positioning of the contact insert may be achieved. For example, an alignment of a conductor connecting region of the contact insert with a conductor insertion channel of the conductor terminal may be achieved for the purpose of a precise positioning. With the aid of the proposed conductor terminal, an easy manufacturing may be advantageously combined with a reliable and easy operability of the conductor terminal. In an example, the chamber narrowing may be reversible, for example using elastic component structures, so that the original chamber width may set in again during a separation of the housing parts from each other at the receiving chamber.

An insulating housing may be a housing made from an electrically insulating material, for example from plastic. The insulating housing may protect the contact insert against environmental influences and against being touched. The insulating housing has a first and a second housing part and is therefore provided with a multi-part design. The first and second housing parts are connectable to each other by an, in particular, detachably designed plug connection and are designed to receive the contact insert in an interior of the insulating housing securely and in a protected manner in the assembled state. A plug contour of the first housing part and a mating plug contour of the second housing part are designed to match each other, so that they may be connected to each other. For example, the plug contour may form a negative contour of the mating plug contour or vice versa. The plug connection may be optionally designed as a snap-in connection, in which the plug contour and the mating plug contour may have a latching edge and a latching element engaging behind the latching edge for the purpose of provided a plug connection which is secured against unintentional detachment.

The contact insert may be a one-part contact element or a multi-part contact assembly including an electrically conductive contact piece, which is designed to establish an electrical connection between an electrical conductor connectable to the contact insert and a connecting contact of the conductor terminal. According to an example, which is explained in greater detail below, the contact insert may have a spring-force clamping connection. An electrical conductor may be clamped hereby onto the electrically conductive contact piece with spring force support. For this purpose, the contact insert may include, for example, a contact piece having a clamping spring arranged thereon, for example suspended on the contact piece.

A receiving chamber may be a hollow space in the insulating housing, which is designed to receive the contact insert and has, for example, a suitable shaping and appropriate dimensions for this purpose. The receiving chamber may be surrounded and predominantly closed from multiple sides by housing structures of the insulating housing, a conductor insertion channel, for example, being able to open into the receiving chamber for the purpose of guiding an electrical conductor to the contact insert. The insulating housing has two side walls limiting the receiving chamber, which are situated opposite each other and whose distance from each other determines the chamber width of the receiving chamber. When assembling the conductor terminal, the contact insert may be arranged between the two side walls situated opposite each other. A width of the contact insert may essentially correspond to the chamber width of the receiving chamber, i.e. to the maximum degree, or it may be smaller than the chamber width, so that, if desired, a side clearance of the contact insert between the side walls situated opposite each other is made possible during the assembly process. If the first housing part is subsequently connected to the second housing part by plugging them into each other, the plug contour of the first housing part and the mating plug contour of the second housing part effectuate a narrowing of the receiving chamber when interacting with each other, in that at least one side wall of the receiving chamber is at least partially deformed and/or displaced during the plugging operation. An at least partial deformation and/or displacement may mean, for example, a local or deformation and/or displacement of the side wall at least in sections, so that the entire side wall does not have to be affected by the deformation and/or displacement. However, a deformation and/or displacement may also take place over the entire side wall. In the present case, a deformation and/or displacement may be understood to be, for example, an elastic deformation and/or displacement, so that the resulting deformation or deflection of the side wall is, in principle, reversible. For this purpose, the side walls of the receiving chamber may be designed to have a limited elasticity, for example by means of a suitable material or a suitable shaping, for example a limited flexural rigidity.

The plug contour of the first housing part may be designed as a socket-shaped plug contour, and the mating plug contour of the second housing part may be designed as a pin-shaped mating plug contour. Easily interconnectable plug and mating plug contours which match each other may be easily provided hereby. As a pin-shaped mating plug contour, the latter may be insertable into the socket-shaped plug contour. A socket-shaped plug contour may be a component structure having an elongated channel. A pin-shaped mating plug contour may be a component structure having an elongated projection. To form a plug connection, the pin-shaped mating plug contour may enter the socket-shaped plug contour, at least in sections. It is possible, although not absolutely necessary, for the mating plug contour to be insertable or inserted all the way into the plug contour.

The plug contour of the first housing part may be designed as a plug channel, at least one channel wall of the plug channel forming a side wall of the receiving chamber of the first housing part. The plug contour may be integrated hereby into the housing structure of the first housing part in a compact manner. When establishing a plug connection between the plug channel and the mating plug contour, a direct displacement and/or deformation of the side wall of the receiving chamber may also be achieved, since the mating plug contour is guided in the plug channel along the side wall.

The mating plug contour of the second housing part may have a spreading contour. A displacement and/or deformation of the side wall of the receiving chamber effectuated with the aid of the mating plug contour may be reliably effectuated or reinforced hereby. A spreading contour may be, for example, a wing-type projection or a projecting radius on the mating plug contour. The spreading contour may protrude, for example, radially from an elongated, in particular pin-shaped, mating plug contour. According to one advantageous refinement, the mating plug contour may have multiple spreading contours protruding from the mating plug contour, for example, to be able to displace and/or deform one side wall of the two adjacent receiving chambers in each case in an insulating housing having multiple receiving chambers and an insertion of the mating plug contour between two adjacent receiving chambers.

The mating plug contour may have an insertion chamfer for inserting the mating plug contour into the plug contour. The mating plug contour may be more easily inserted hereby into the plug contour, and a gradual deformation and/or displacement of the side wall of the receiving chamber may be facilitated. For this purpose, the mating plug contour may be advantageously designed as a pin-shaped mating plug contour, and the plug contour may be advantageously designed as a socket-shaped plug contour. A mating plug contour having an insertion chamfer may be advantageous, in particular, if the mating plug contour has a spreading contour, or if the plug contour of the first housing part and the mating plug contour of the second housing part are configured with an interference fit with respect to each other. The insertion chamfer may be arranged on the mating plug contour in such a way that it faces the plug contour during an insertion of the mating plug contour into the plug contour and enters the plug contour as the first partial region of the mating plug contour.

The mating plug contour may have a guide bar for guiding the mating plug contour along the plug contour. The establishment of a plug connection between the plug contour and the mating plug contour may be simplified and supported hereby. For this purpose, the mating plug contour may be advantageously designed as a pin-shaped mating plug contour, and the plug contour may be advantageously designed as a socket-shaped plug contour. The guide bar may be designed, for example, to be guided along the outside of the plug contour for the purpose of orienting the mating plug contour with respect to the plug contour and making a connection easier. According to one refinement, the mating plug contour may also have multiple guide bars, which may receive the plug contour between them in a bracketed manner and effectuate a centered orientation of the mating plug contour with respect to the plug contour. If the plug contour of the first housing part is designed as a plug channel, at least one channel wall of the plug channel forming a side wall of the receiving chamber of the first housing part, the guide bar may also achieve a stabilization of the displaced and/or deformed side wall, in that it is guided along the side wall on the outside of the plug channel and at least partially limits the deflection and/or deformation thereof.

The plug contour of the first housing part and the mating plug contour of the second housing part may be configured to have an interference fit with respect to each other. For example, the mating plug contour may have a greater width or a larger diameter than the plug contour if it is designed for insertion into the plug contour. For example, a pin-shaped mating plug contour may have a larger diameter perpendicularly to a plug-in direction of the mating plug contour than an assigned socket-shaped plug contour. Due to the configuration with an interference fit, the mating plug contour may be designed to widen the plug contour, which may result in a deformation and/or displacement of a side wall of the receiving chamber. A structurally simple example may thus be provided for reducing a chamber width of the receiving chamber with the aid of the plug and mating plug contours.

The insulating housing may have at least two receiving chambers extending in parallel to each other, in each case for receiving a contact insert for connecting an electrical conductor. This makes it possible to connect multiple electrical conductors to the conductor terminal. The conductor terminal may therefore have multiple connections, which are each provided by a contact insert. Each contact insert may be arranged in its own receiving chamber. The receiving chambers may be arranged one after the other, the contact inserts being able to be oriented, for example, in parallel to each other in the receiving chambers.

At least one side wall of a receiving chamber may form a separating structure to an adjacent receiving chamber. A compact arrangement and a structural separation of the receiving chambers may be achieved hereby with sufficient air gaps and creepage distances. For example, two receiving chambers adjacent to each other may be separated from each other by a shared or a separate side wall in each case in the form of a double wall.

The plug contour of the first housing part may be designed as a plug channel, and two channel walls of the plug channel situated opposite each other may each form a side wall of two adjacent receiving chambers. This makes it possible for a mating plug contour inserted into the plug channel to achieve a simultaneous displacement and/or deformation of the side walls of two adjacent receiving chambers forming the plug channel, so that an efficient chamber narrowing may be implemented at two receiving chambers at the same time.

The chamber width of a receiving chamber may be smaller than the contact spacing of the insulating housing. In particular, a chamber width reduced by the deformation and/or displacement of at least one side wall of the receiving chamber may be smaller than the contact spacing of the insulating housing. Contact spacing may be understood to be, for example, a distance between the central longitudinal axes of adjacent conductor insertion openings of the insulating housing, through which electrical conductors to be connected may be guided to adjacent receiving chambers.

The contact insert may have a clearance in the receiving chamber when the first housing part and the second housing part are not connected to each other, and the contact insert may have a clearance which is reduced thereto or eliminated when the first housing part and the second housing part are connected to each other. The clearance may be, in particular, a clearance in the direction of the chamber width, i.e. a clearance between the side walls of the receiving chamber, which are situated opposite each other and define the chamber width, and the contact insert. By reducing the chamber width of the receiving chamber, an existing clearance of the contact insert in the receiving chamber may therefore be reduced or eliminated entirely. The contact insert may be first easily mounted hereby in the receiving chamber and oriented with respect to each other and fixed during a connection of the housing parts for the purpose of facilitating a reliable and easy connection of an electrical conductor to the conductor terminal. If the conductor terminal is designed as a plug connector, a mating plug connector may be more easily inserted and connected.

The contact insert may have a spring-force clamping connection. A spring-force clamping connection is a conductor connection having a clamping spring, with the aid of which an electrical conductor may be clamped to an electrically conductive contact piece of the contact insert by means of spring force. An electrical conductor may be easily connected with little application of force and contacted securely with the aid of a spring-force clamping connection. In that the clamping spring forms a moving part of the contact insert, it is advantageous if the contact insert may be inserted into the receiving chamber of the conductor terminal with clearance. It is also favorable that the contact insert may be precisely oriented by a reduction of the chamber width of the receiving chamber, for example, for the purpose of an alignment with a conductor insertion channel of the conductor terminal, and may be fixed in the oriented position.

The conductor terminal may include an actuating element for actuating the spring-force clamping connection. An actuating element may be, for example, an actuating lever or an actuating pushbutton, which may displace a clamping leg of the clamping spring from a clamping position into an open position to make it easier to insert an electrical conductor into the conductor terminal in the region of the clamping point or to release a connected electrical conductor. If the contact insert of the conductor terminal is precisely positioned and fixed in the receiving chamber, the actuation of the spring-force clamping connection may be implemented reliably and with little application of force.

The first housing part and the second housing part may form a shared elongated receiving chamber for the contact insert, the receiving chamber of the first housing part having a first chamber section, and the second housing part having a second chamber section. The second chamber section of the second housing part forms an elongation of the receiving chamber of the first housing part in the connected state of the first and second housing parts. The assembly of the conductor terminal may be further simplified hereby, since the contact insert needs to be placed only in a partial region of the receiving chamber, and the latter is fully formed and closed only by joining the housing parts. For example, the side walls defining the chamber width of the receiving chamber and situated opposite each other may be formed partially by the first housing part and partially by the second housing part and be assembled during the establishment of a plug connection between the housing parts.

The first housing part may have at least one plug connection for establish an electrical connection to the contact insert. The conductor terminal may be designed as a plug connector hereby. Plug connectors permit an easy and fast establishment of a detachable electrical connection between the plug connector and an electrical mating plug connector. For this purpose, the first housing part may have a plug connection, which is aligned with a corresponding mating plug connection of a mating plug connector for the purpose of a connection. The plug connection may have, for example, a socket-shaped or pin-shaped plug contact element. The plug connection may form a connecting contact of the conductor terminal described above. The second housing part can have at least one plug connection for establishing an electrical connection to the contact insert.

The second housing part may have at least one conductor insertion opening for guiding an electrical conductor to the contact insert. For this purpose, an electrical conductor may be safely guided to the contact insert through the insulating housing. A conductor insertion channel, which opens into the receiving chamber and permits a precise guidance of the electrical conductor to the contact insert, may abut the conductor insertion opening. It is provided, in an example, that the first housing part can have at least one conductor insertion opening for guiding an electrical connection to the contact insert.

The invention further relates to a method for assembling a conductor terminal, which includes an insulating housing and a contact insert, comprising the steps: providing a first housing part of the insulating housing, the first housing part having a plug contour and a receiving chamber with two side walls situated opposite each other for receiving the contact insert, and a distance between the side walls situated opposite each other defining a chamber width of the receiving chamber; providing a second housing part of the insulating housing, the second housing part having a mating plug contour, which is designed for plug connection to the plug contour of the first housing part; providing the contact insert; inserting the contact insert into the receiving chamber of the first housing part; and establishing a plug connection between the first housing part and the second housing part, the mating plug contour of the second housing part being designed to reduce the chamber width of the receiving chamber, at least in sections, during the establishment of the plug connection by at least partially deforming and/or displacing at least one side wall of the receiving chamber of the first housing part.

This makes it possible to easily arrange the contact insert in the first housing part, in particular with clearance, in one assembly step and to achieve a fixing of the contact insert in the receiving chamber in a further assembly step during the fastening of the second housing part, a clearance of the contact insert which may be present in the receiving chamber being advantageously reduced or eliminated entirely. The conductor terminal may be designed, in particular, according to one of the features described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an insulating housing of a conductor terminal, which includes a first and a second housing part, in a connected state in a cutaway top view;

FIG. 2 schematically shows the insulating housing illustrated in FIG. 1 in a perspective cutaway top view;

FIG. 3 schematically shows an exploded representation of the first and second housing parts before they are connected to each other;

FIG. 4 schematically shows the first housing part of the insulating housing illustrated in FIG. 1 in an isolated representation, in the deformed state of the side walls, in a front view;

FIG. 5 schematically shows the second housing part of the insulating housing illustrated in FIG. 1 in an isolated representation, in a front view; and

FIG. 6 shows a simplified flowchart of a method for assembling a conductor terminal.

### DETAILED DESCRIPTION

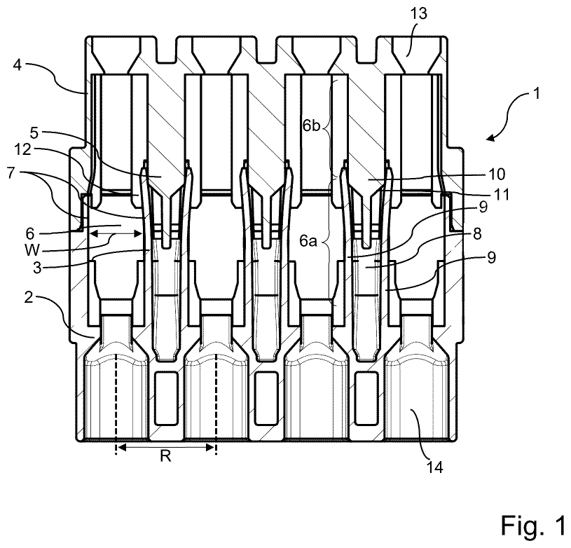

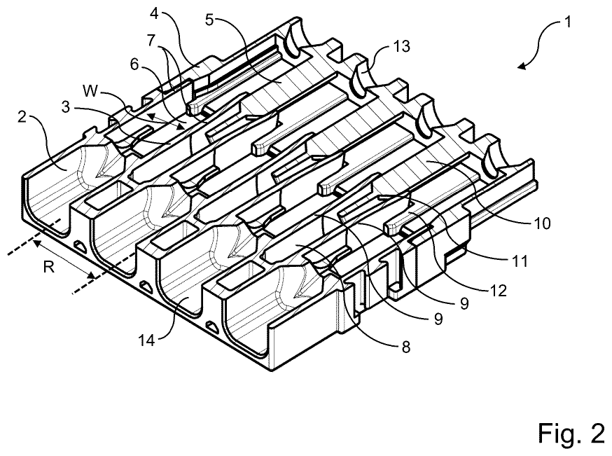

FIGS. 1 and 2 show an insulating housing 1 of a conductor terminal, which includes a first housing part 2 and a second housing part 4. According to the illustrated example, first housing part 2 has socket-shaped plug contours 3. According to the illustrated example, second housing part 4 has pin-shaped mating plug contours 5. Mating plug contours 5 are designed for plug connection with plug contours 3 of first housing part 2. In FIGS. 1 and 2, first housing part 2 and second housing part 4 are shown in a connected state, in which a plug connection is established between plug contours 3 and mating plug contours 5. First housing part 2 has multiple receiving chambers 6, each with side walls 7 situated opposite each other for receiving one contact insert in each case. A distance between side walls 7 situated opposite each other defines in each case a chamber width W of a receiving chamber 6.

Mating plug contours 5 of second housing part 4 are designed to at least partially deform and/or displace at least one side wall 7 of a receiving chamber 6, in each case during the establishment of the plug connection between plug contour 3 of first housing part 2 and mating plug contour 5 of second housing part 4, so that chamber width W of receiving chamber 6 is reduced, at least in sections. Receiving chamber 6 may be narrowed hereby in such a way that a contact insert situated in receiving chamber 6 is oriented and fixed. A contact insert may thus be easily arranged in first housing part 2, in particular with clearance, during the manufacturing of the conductor terminal, and fixed by narrowing receiving chamber 6 during the fastening of second housing part 4 to first housing part 2. Side wall 7 may be elastically deformable and/or displaceable, for example by means of a suitable material or a suitable shaping, for example, by a narrow, elongated structural design, so that the chamber narrowing is reversible when housing parts 2, 4 are separated from each other, and original chamber width W may set in again upon a separation of housing parts 2, 4.

As is apparent in FIGS. 1 and 2, plug contours 3 of first housing part 2 may be designed as plug channels 8, at least one channel wall 9 of a plug channel 8 forming a side wall 7 of a receiving chamber 6 of first housing part 2. Plug contours 3 may be integrated hereby into the housing structure of first housing part 2 in a compact manner, and a direct deformation and/or displacement of a side wall 7 may be effectuated when mating plug contour 5 is guided along side wall 7 in a plug channel 8.

According to the example illustrated in FIGS. 1 and 2, insulating housing 1 has multiple, in the illustration four, receiving chambers 6 extending in parallel to each other for receiving a contact insert in each case. This makes it possible to connect multiple electrical conductors to the conductor terminal. As is further apparent from FIGS. 1 and 2, side walls 7 of receiving chambers 6 may each form a separating structure with respect to an adjacent receiving chamber 6, so that a compact arrangement is provided. Plug contours 3 designed as plug channels 8 have two channel walls 9 situated opposite each other, which each form a side wall 7 of two adjacent receiving chambers 6. It is furthermore illustrated that chamber width W of a receiving chamber 6 is smaller than contact spacing R of insulating housing 1, which may be described as a distance between the central longitudinal axes of adjacent conductor insertion openings 14.

As is apparent in FIGS. 1 and 2, first housing part 2 and second housing part 4 together may form receiving chambers 6, in each case a first chamber section 6a being formed by first housing part 2 and a second chamber section 6b being formed by second housing part 4. The assembly of the conductor terminal may be further simplified hereby. It is furthermore apparent that second housing part 4 has plug connections 13 for establishing an electrical connection to the contact inserts, so that the conductor terminal is designed as a plug connector and may be connected to an electrical mating plug connector. It is also apparent from FIGS. 1 and 2 that second housing part 4 has conductor insertion openings 14 for guiding electrical conductors to the contact inserts, so that electrical conductors may be easily and reliably connected to the conductor terminal.

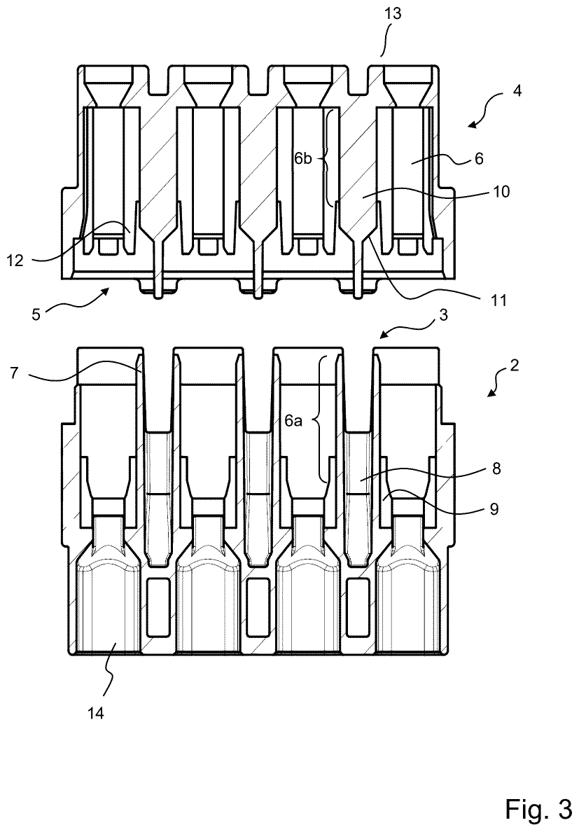

FIG. 3 shows an exploded representation of first and second housing parts 2, 4 before they are connected to each other. On the plug-in side, which is situated opposite conductor insertion openings 14, first housing part 2 has protruding side walls 7, which form a channel closed on the circumferential side with a base wall and a cover wall. On the plug-in side situated opposite plug openings 13, second housing part 4 has a mating plug contour 5, which includes guide bars 12 and spreading contours 10. An intermediate space is present in each case between a guide bar 12 and a spreading contour 10, which is designed to receive the end region of a side wall 7 protruding on the plug-in side of first housing part 2.

A plug channel 8, which is limited by channel walls 9 and is designed to receive spreading contour 10, is formed in each case between a pair of side walls 7.

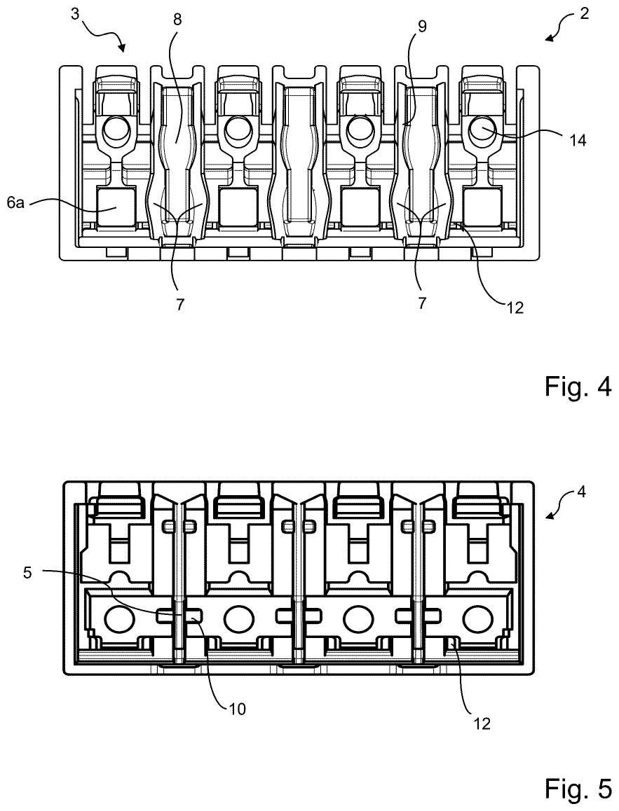

FIG. 4 shows first housing part 2 of the insulating housing illustrated in FIG. 1 in an isolated representation, in the deformed state of side walls 7, in a front view.

It is apparent that side walls 7 are each deformed in the direction of adjacent first chamber section 6a of receiving chamber 6. The width of receiving chamber 6 is reduced thereby. A plug channel 8, which is designed to receive spreading contour 10, is formed in each case between a pair of adjacent side walls 7. By inserting spreading contour 10, which has an insertion chamfer 10 and is wider than plug channel 8, side walls 7 are pressed laterally out of plug channel 8 and deformed.

Second housing 4 is additionally illustrated in FIG. 5 in an isolated representation in a front view. It is apparent from FIG. 5 that mating plug contours 5 of second housing part 4 have spreading contours 10. A displacement and/or deformation of side walls 7 effectuated with the aid of mating plug contours 5 may be reliable effectuated or reinforced hereby. According to the illustrated example, spreading contours 10 are designed as wing-like projections protruding from pin-shaped mating plug contours 5 and are designed to at least partially displace and/or deform side walls 7 of two adjacent receiving chambers 6. A spreading contour 10 may have, in particular, a greater cross-sectional width than a plug channel 8. An interference fit between plug contour 3 and mating plug contour 5 may be provided hereby with the aid of spreading contour 10. In an example without a spreading contour 10, pin-shaped mating plug contour 5 itself may also have a greater cross-sectional width than plug channel 8.

It is furthermore apparent that mating plug contours 5 have an insertion chamfer 11, which makes it easier to insert mating plug contours 5 into plug contours 3 and facilitates a gradual deformation and/or displacement of side walls 7. In interaction with spreading contours 10, a gradual spreading apart of plug channel 8 may thus be achieved, which brings about a gradual chamber narrowing and thus a gentle fixing of the contact insert.

It is furthermore apparent from FIG. 5 that mating plug contours 5 each have two guide bars 12. Guide bars 12 are designed to slide along a surface of a plug contour 3 and make it easier to establish a plug connection between plug contours 3 and mating plug contours 5. In addition, guide bars 12 may receive plug contours 3 between themselves in a bracket-like manner and effectuate a centered orientation of a mating plug contour 5 with respect to a plug contour 3.

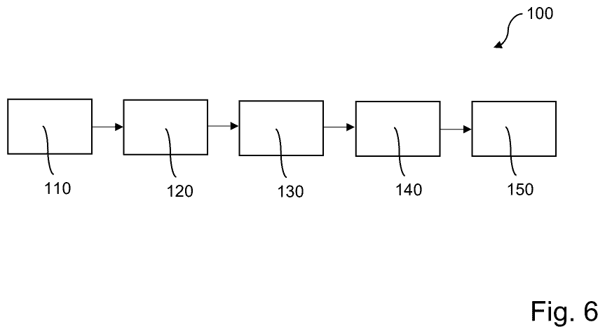

FIG. 6 schematically shows a flowchart of a method 100 in a greatly simplified block diagram for assembling a conductor terminal, which includes an insulating housing 1 and a contact insert. According to a first step 110, a provision of a first housing part 2 of insulating housing 1 takes place, first housing part 2 having a plug contour 3 and a receiving chamber 6 with two side walls 7 situated opposite each other for receiving the contact insert, and a distance between side walls 7 situated opposite each other defining a chamber width W of receiving chamber 6. According to a further step 120, a provision of a second housing part 4 of insulating housing 1 takes place, second housing part 4 having a mating plug contour 5, which is designed for plug connection to plug contour 3 of first housing part 2. According to a further step 130, a provision of the contact insert takes place. According to a further step 140, an insertion of the contact insert into receiving chamber 6 of first housing part 2 takes place. According to a further step 150, an establishment of a plug connection between first housing part 2 and second housing part 4 takes place, chamber width W of receiving chamber 6 being reduced, at least in sections, with the aid of mating plug contour 5 of second housing part 4 during the establishment of the plug connection by at least partially deforming and/or displacing at least one side wall 7 of receiving chamber 6 of first housing part 2.

With the aid of the described conductor terminal and the described assembly method, an easy manufacturing may be advantageously combined with a reliable and easy operability of the conductor terminal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a contact insert to connect an electrical conductor; and
an insulating housing including a first housing part, which has a plug contour, and a second housing part, which has a mating plug contour, which is designed for plug connection to the plug contour of the first housing part, the first housing part having a receiving chamber with two side walls arranged opposite each other for receiving the contact insert, and a distance between the side walls arranged opposite each other defining a chamber width of the receiving chamber,
wherein the mating plug contour of the second housing part is designed to reduce the chamber width of the receiving chamber, at least in sections, during establishment of a plug connection between the plug contour of the first housing part and the mating plug contour of the second housing part by at least partially deforming and/or displacing at least one side wall of the receiving chamber of the first housing part.

2. The conductor terminal according to claim 1, wherein the plug contour of the first housing part is designed as a socket-shaped plug contour, and the mating plug contour of the second housing part is designed as a pin-shaped mating plug contour.

3. The conductor terminal according to claim 1, wherein the plug contour of the first housing part is designed as a plug channel, and wherein at least one channel wall of the plug channel forms a side wall of the receiving chamber of the first housing part.

4. The conductor terminal according to claim 1, wherein the mating plug contour of the second housing part has a spreading contour.

5. The conductor terminal according to claim 1, wherein the mating plug contour has an insertion chamfer for inserting the mating plug contour into the plug contour.

6. The conductor terminal according to claim 1, wherein the mating plug contour has a guide bar to guide the mating plug contour along the plug contour.

7. The conductor terminal according to claim 1, wherein the plug contour of the first housing part and the mating plug contour of the second housing part are configured to having an interference fit.

8. The conductor terminal according to claim 1, wherein the insulating housing has at least two receiving chambers extending in parallel to each other for receiving a contact insert for connecting an electrical conductor.

9. The conductor terminal according to claim 8, wherein at least one side wall of a receiving chamber forms a separating structure with respect to an adjacent receiving chamber.

10. The conductor terminal according to claim 8, wherein the plug contour of the first housing part is designed as a plug channel, and two channel walls of the plug channel arranged opposite each other each form a side wall of two adjacent receiving chambers.

11. The conductor terminal according to claim 8, wherein the chamber width of a receiving chamber is smaller than the contact spacing of the insulating housing.

12. The conductor terminal according to claim 1, wherein the contact insert has a clearance in the receiving chamber when the first housing part and the second housing part are not connected to each other, and wherein the contact insert has a clearance which is reduced thereto or eliminated when the first housing part and the second housing part are connected to each other.

13. The conductor terminal according to claim 1, wherein the contact insert has a clamping spring-force clamping connection.

14. The conductor terminal according to claim 13, wherein the conductor terminal has an actuating element for actuating the spring-force clamping connection.

15. The conductor terminal according to claim 1, wherein the receiving chamber of the first housing part forms a first chamber section, and the second housing part has a second chamber section, the first and second chamber sections together forming an elongated receiving chamber for the contact insert.

16. The conductor terminal according to claim 1, wherein the first housing part has at least one plug connection for establishing an electrical connection to the contact insert.

17. The conductor terminal according to claim 1, wherein the second housing part has at least one conductor insertion opening for guiding an electrical conductor to the contact insert.

18. A method for assembling a conductor terminal, which includes an insulating housing and a contact insert, the method comprising:
providing a first housing part of the insulating housing, the first housing part having a plug contour and a receiving chamber with two side walls arranged opposite each other for receiving the contact insert, and a distance between the side walls arranged opposite each other defining a chamber width of the receiving chamber;
providing a second housing part of the insulating housing, the second housing part having a mating plug contour, which is designed for plug connection to the plug contour of the first housing part;
providing the contact insert;
inserting the contact insert into the receiving chamber of the first housing part; and
establishing a plug connection between the first housing part and the second housing part, the chamber width of the receiving chamber being reduced, at least in sections, with the aid of the mating plug contour of the second housing part during the establishment of the plug connection by at least partially deforming and/or displacing at least one side wall of the receiving chamber of the first housing part.
